(19) United States
(12) Patent Application Publication
(10) Pub. No.: US 2008/0113678 A1
(43) Pub. Date: May 15, 2008

(54) SOCIAL CAPITALIZATION NETWORK COMMUNICATION SYSTEM

(76) Inventors: John Hand, Tucson, AZ (US); Debra Brown, Tucson, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/929,499

(22) Filed: Oct. 30, 2007

Related U.S. Application Data
(60) Provisional application No. 60/865,039, filed on Nov. 9, 2006.

(51) Int. Cl. H04Q 7/20

(52) U.S. Cl. 455/466

(57) ABSTRACT

An interactive network service uses communications technology such as the Internet (e.g.; Web pages), Short Message Service (SMS) text messaging, Multi-Media Messaging (MMS), WAP and E-mail to combat community deterioration and create social capital by filling the structural holes that exist between and within individuals, civic groups, and business.

### RELATED APPLICATIONS

This U.S. patent application claims priority to U.S. Provisional Application Ser. No. 60/865,039, filed on Nov. 9, 2006, which is incorporated herein by reference.

### TECHNICAL FIELD

This invention relates to network communications, and is more particularly related to network communications between and within individuals, civic groups, and businesses.

### BACKGROUND

As electronic text communications replace personal letters being mailed and face-to-face meetings, community deterioration progresses and social capital decreases from an increase in structural holes that exist in communications between and within individuals, civic groups, and businesses.

The foregoing problem is supported by various social theorists. In Robert Putnam's research on the disappearance of social capital in America, his empirical evidence supports the theory that since the 1930's there has been a significant decrease in civic engagement, which has contributed to the erosion of social capital. This decrease is problematic in that it is social capital that is the glue that holds the fabric of society together. Similarly, in support of Noah Mark's theory of social differentiation and technology, Mark uses computer simulation to demonstrate that as the size of a community increases, social differentiation increases. Mark advanced the theory that as a society gets bigger, there will be a decrease in cultural homogeneity and memory (the capacity to store information/knowledge), while there will be an increase in social differentiation. Moreover, social differentiation can provide the foundation for inequality because resources flow through network ties. Thus, the more stratified a society becomes, the fewer the ties exist between different groups of people. Technology can increase memory, which in turn decreases social differentiation.

Ronald Burt, writing on the contingent value of social capital, argued that structural holes are disconnections between non-redundant contacts in a network. In a network which consists of autonomous subgroups, structural holes represent the lack of ties between the various subgroups. Structural holes provide an opportunity to broker the flow of information between people and to control the form of projects that bring together people from opposite sides of the hole. As such, filling structural holes creates social capital.

Given the foregoing societal communication problem, it would be an advantage in the art to provide a social capitalization network communication system that uses technology to combat community deterioration and create social capital by filling the structural holes that exist between and within individuals, civic groups, and businesses.

### SUMMARY

Implementations provide for an interactive network service that uses communications technology such as the Internet (e.g.; Web pages), Short Message Service (SMS) text messaging, Multi-Media Messaging (MMS), WAP and E-mail to combat community deterioration and create social capital by filling the structural holes that exist between and within individuals, civic groups, and businesses.

### BRIEF DESCRIPTION OF THE DRAWINGS

A more complete understanding of the implementations may be had by reference to the following detailed description when taken in conjunction with the accompanying drawings wherein:

FIG. 1 depicts an exemplary environment for an implementation of a social capitalization network communication system.

### DETAILED DESCRIPTION

I. Concept.

Implementations, in concept, provide a social networking system, sometimes referred to herein as “Intextmessage”, that uses information technology services such as the Internet (e.g.; Web pages), Short Message Service (SMS) text messaging, Multi-Media Messaging and emails to enable businesses, organizations, and individuals to build and maintain social capital by increasing the speed and effectiveness with which they communicate with one another. Implementations also create new channels of communication by filling structural holes that exist between and among the various niches within a community. In various implementations, a social networking system is managed through a website assessable through a hyperlinked Universal Resource Locator (URL) or logical World Wide Web address (e.g.; www.Intextmessage.com).

The integration of SMS text messaging and Multi-Media Messaging into the social networking website makes Intextmessage.com a powerful mobilization tool. Not everybody checks their email multiple times throughout the day; but most people take their mobile phones everywhere. Whether it is a local hospitality establishment (e.g.; a hotel, club, tavern, etc.) reminding its patrons of the evening's entertainment, a humanitarian group organizing an emergency demonstration, or a soccer coach canceling practice at the last minute; SMS text messaging and Multi-Media Messaging provides a more effective method of delivering timely information to people regardless of their location.

Intextmessage.com is unique in that it is an all-inclusive approach to social networking. Rather than catering to a particular niche or demographic, the website centralizes information pertaining to the arts and entertainment, sports and recreation, politics, dining, volunteerism, community resources, job opportunities, educational programs, and virtually anything else that falls within the public sphere. Accordingly, Intextmessage.com provides people from all walks of life with a comprehensive overview of community life, and a one-stop-shop for meeting others, and finding location based activities pursuant to their interests. At the same time, it enables the community groups and businesses that set up group pages on Intextmessage.com to reach a much larger more diverse audience than they can through independent mobile marketing efforts.

II. Services.

A. For Individuals.

Once an individual registers on Intextmessage.com, he or she will have the opportunity to create and join “social cliques” (social text messaging groups) pursuant to his or her interests. Social cliques can be used to make communication easier within an existing group, or to help people find others who share a particular interest. For example, a book club might set up a group page to send meeting announcements to its members, while a couple that likes playing tennis might start a group in order to find doubles matches. Individuals in social cliques can send group text messages and/or emails, as well as exchange information with subsets of people in the group. Social clique group members can also send and respond to group polls/votes, and/or RSVP to group events. Furthermore, individuals can forward messages they receive from other groups they are in (social cliques, community groups, and business groups) to any other social clique they are a member of. Social clique group members can also send messages from the website or their mobile phones. Finally, website users can use the scheduling system to send themselves reminders of upcoming group events, or even personal activities such as a doctor appointment.

Website users can also join groups (from their mobile phones or from the Intextmessage.com website) set up by community organizations and local businesses. By joining a group, an individual consents to receiving text messages, multimedia messages and/or email messages from that group. Website users receive messages only from the groups they join, so users never receive unsolicited messages. Individuals can also search local business events and specials from their phones by using “mobile keywords” selected by business groups. “mobile key words” such as music, baseball, Indian food, bar specials etc. would warrant results an individual could choose from.

B. For Community Groups.

There are many ways in which nonprofit organizations, student clubs, governmental entities, and other formal associations can benefit from setting up group pages on Intextmessage.com. First, the website can be used for internal communication among the various groups. For instance, a high school sends out a reminder message to all choir members reminding them of tomorrow's rehearsal. Next, community groups can use their group page to promote their organizational goals, services offered and activities, because Intextmessage represents a broad demographic with broad interests. In doing so, community groups can recruit new members, volunteers, participants, and or donors from a pool of people who may not otherwise know of the organization, or the opportunities to get involved. Community groups can also interact with their Intextmessage group members by sending polls, conducting votes, and requesting RSVPs for the events the group sponsors. Additionally, by setting up a group page on Intextmessage.com, community groups become eligible to receive funding from the Syzygic foundation. Community groups can also generate revenue by allowing their group emails and SMS messages to be sponsored.

Community groups are more structured. They have a maintainer who sets the membership requirements, as well as roles and permissions of members. Only the maintainer, or individuals appointed by the maintainer can send out group messages, and set the parameters for who can reply to whom and what. The Intextmessage automated scheduling system conveniently enables group maintainers to schedule message delivery in advance.

C. For Businesses with Group Pages.

Businesses can use their group pages to establish a more intimate relationship with current patrons. Once an individual joins a business's group page the establishment can send him or her time-sensative information about promotions, specials, and upcoming events via SMS text messaging or email. For example, if a pizzeria has too much pizza at the end of a night, rather than throwing it away, the business can send a message to group members telling them, “from now until close, all slices are half off regular price.” Business group pages also serve as an extension of the establishments' website. Business groups can also benefit from the interactive Intextmessage features such as polling, conducting votes, and requesting RSVPs for upcoming events. Businesses can also purchase “mobile keywords” and determine how much they are willing to pay for use of a particular term. The search results are displayed accordingly on the mobile phone of the individual conducting the search. Additionally, by linking their Intextmessage.com group page to their company website, the business can drive traffic to their website and attract new clientele.

Group pages are ideal for establishments that regularly host events and activities such as open microphones for use of patrons, live music, family nights, poker tournaments, etc; and/or businesses that have specials that change frequently.

D. For Targeted Ad Sponsors.

Intextmessage allows businesses to advertise via headers or footers that are attached to the emails, SMS/MMS text messages, and multimedia messages sent out by social cliques and sponsored community groups. Intextmessage's data mining program sorts the information users submit in order to ensure that the sponsored ads are only sent to individuals who have already identified an interest in the advertisers' products and/or services.

For example; Joe, Sarah, and Destiny are all in the Moviegoers Clique. They all like movies, but Joe likes video games, Sarah likes tennis, and Destiny likes ethnic food. They all receive a message that says, “the moviegoers are invited to a short film festival at the loft on Oct. 29, 2008. Show starts at 7:00 PM and admission is $5.00.” Joe's message says, “Brought to you by Computer USA . . . , Sarah's message is sponsored by a local country club, and Destiny's ad lists a limited time special at a chain restaurant. The data mining programs also allow for the sponsored advertisements to be delivered to individuals based on the ad's relevance to the content of the group message. For example: Natalie, Ted, and Max are all in a pick up basketball clique. Natalie sends out a message about playing in an outdoor three-on-three tournament next Saturday. Ted and Max receive her message with an attached advertisement for a new Gatorade flavor.

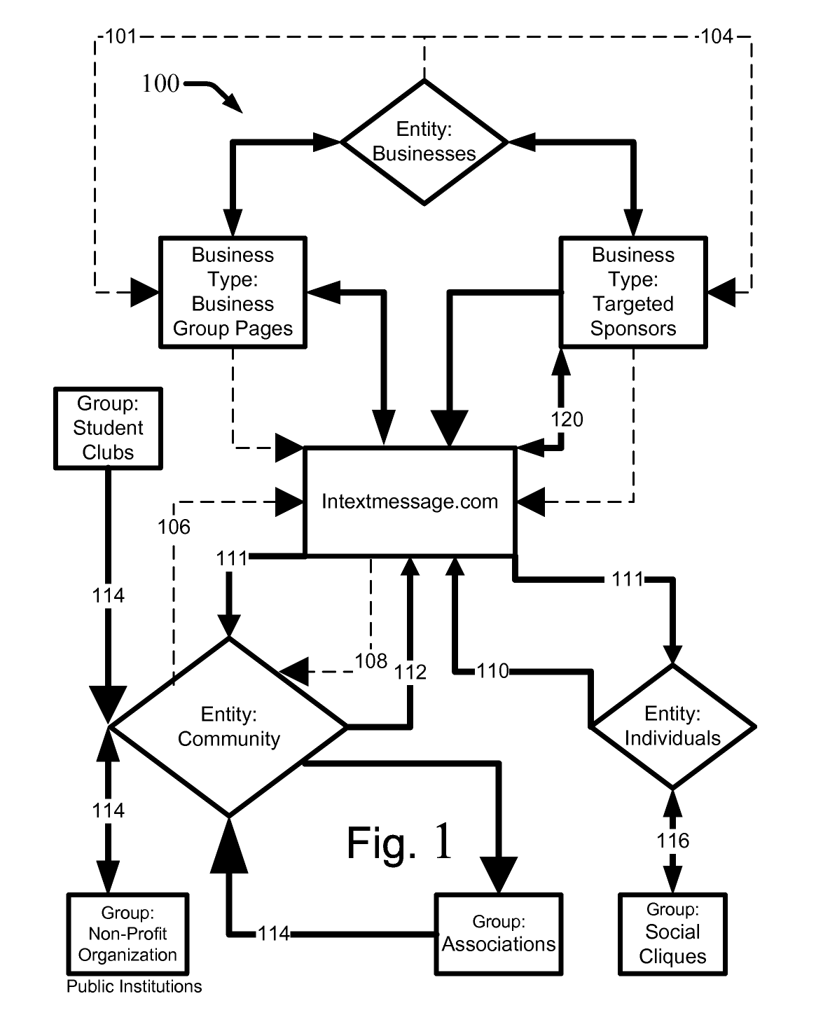

Referring now to FIG. 1, an exemplary environment 100 is shown for an implementation of a social capitalization network communication system. Environment 100 depicts various work flows of revenue (dotted arrowed lines) and information (solid arrowed lines) via network communications between and within individuals, civic groups, and businesses in the social capitalization network communication system.

Work flows 101 through 108 represent various financial transactions. In particular, in work flow 101, businesses pay for the SMS/MMS text messages they send out. In work flow 104, name Brands and other companies can purchase targeted advertisements. In work flow 106, community groups that do not want their emails and SMS/MMS text messages to have attached ads pay for the text messages they send out. In work flow 108, eligible community groups that allow their emails and messages to be sponsored receive a small percentage of the revenue generated by their groups ads.

Work flows 10 through 116 represent the delivery of information. In particular, in work flow 110-112, individuals that join social cliques and members of sponsored community groups receive advertisements via headers or footers of the emails and SMS/MMS text messages sent out by their groups. In work flow 114, nonprofit organizations, student clubs, and associations send information to the individuals who join their groups. In work flow 116, individuals in social cliques and informal groups can send group emails and/or text messages, as well as exchange information with other individuals in the group. Work flow 120 represents feedback to companies that purchase targeted ad's. Feedback comes in at least two forms. This feedback allows purchasers of targeted ads to gain information on the population they are advertising to by way of demographics and “targeted ad satisfaction” (whether a targeted ad is to be accepted, rejected, deferred, or commented on).

III. Exemplary Implementations.

A. Implementation A.

Implementation A is facilitated by way of cellular, Internet and databases technologies, and included the following exemplary method of processing batch opt-in requests via SMS/MMS/Internet technologies. In implementation A, the following definitions will apply:

Opt-in: a process by which a user knowingly and voluntarily accepts solicited information delivered via SMS/MMS text messaging or e-mail.

Entity: a group, for-profit or non-profit organization. i.e. businesses, sports clubs, social networks, etc.

The purpose of Implementation A is to allow an entity to create a list of SMS/MMS users complete with names, cell phone numbers, locations, email, etc. which in turn is submitted into our system (intextmessage.com). From there, this information is filtered, formatted and validated. Once filtered, our system delivers via SMS/MMS to users that are identified in the created list. This process allows the identified users to opt-in to receive information pertaining to their interests at a later date.

Implementation A includes Step 1 through 2 as follows:

Step 1: The entity wishes to add the following in his or her text message group. They upload a file with the following contact information:

| First name | Last name | Cell Phone # | Location |
|---|---|---|---|
| Jane | Doe | 15551234567 | Cincinnati, OH |
| John | Doe | 15557456123 | Cincinnati, OH |
| Little | Doe | 15553265987 | San Francisco, CA |
| Jauns | Deer | 155578999 | Tucson, AZ |
| Kelly | Piper | 15551222023 | El Paso, TX |

Step 2: This information is filtered (invalid phone number or already sent a prior opt-in request and wishes not receive any more invites, etc.)

| First name | Last name | Cell Phone # | Location |
|---|---|---|---|
| Jane | Doe | 15551234567 | Cincinnati, OH |
| John | Doe | 15557456123 | Cincinnati, OH |
| Little | Doe | 15553265987 | San Francisco, CA |
| Kelly | Piper | 15551222023 | El Paso, TX |

An invalid phone number

| | | | |
|---|---|---|---|
| [symbol] | [symbol] | [symbol] | [symbol] |

Already sent a prior opt-in request but has selected to continue to receive opt-in invitations.

| | | | |
|---|---|---|---|
| Kelly | Piper | 15551222023 | El Paso, TX |

This information is valid for requesting that these users opt-in to Entity B's group.

| First name | Last name | Cell Phone # | Location |
|---|---|---|---|
| Jane | Doe | 15551234567 | Cincinnati, OH |
| John | Doe | 15557456123 | Cincinnati, OH |
| Little | Doe | 15553265987 | San Francisco, CA |
| Kelly | Piper | 15551222023 | El Paso, TX |

Each user will then receive a SMS/MMS message containing the following:
SMS/MMS to Jane Doe-15551234567
Hey this is Entity B inviting you to our text messages group to receive information about deals and specials. Jane, to opt-in REPLY with “ADD ME”.
SMS/MMS to John Doe-15557456123
Hey this is Entity B inviting you to our text messages group to receive information about deals and specials. John, to opt-in REPLY with “ADD ME”.
SMS/MMS to Little Doe-15553265987
Hey this is Entity B inviting you to our text messages group to receive information about deals and specials. Little, to opt-in REPLY with “ADD ME”.
SMS/MMS to Kelly Piper-15551222023
Hey this is Entity B inviting you to our text messages group to receive information about deals and specials. Kelly Piper, to opt-in REPLY with “ADD ME”. If you do not want to receive invitation in the future REPLY with “INVITE-OFF”.
Once these users opt-in to receive information from Entity B, they can be sent information from Entity B. If any of these users at a later date decides not to receive information they may leave the Entity B's group.

B. Implementation B.

Implementation B is a way of sending information from a cellular device to many cellular devices, PDAs, computers, etc. In implementation B, the following definitions will apply:

Opt-in: a process by which a user knowingly and voluntarily accepts solicited information delivered via SMS/MMS text messaging or e-mail.

Entity: a group, for-profit or non-profit organization. i.e. businesses, sports clubs, social networks, etc.

The purpose of Implementation B is to allow an appointed group member on the system (intextmessage.com) to send a SMS/MMS text message from her or his phone to large numbers of people in their group delivered via text message or e-mail (depending on individual user preferences).

The process for Implementation B is that an appointed group member maintains an emergency response group called (ERHS) of 1400+ students. An emergency situation arises when a car crashes into the school's cafeteria cutting power to the entire building. The appointed group member sends an SMS/MMS text message to our system (intextmessage.com) which in turn goes out to all 1400+ opt-in participants in the emergency response group.

Example of the actual text message sent.
“msg-ERHS-Please evacuate outside to your designated post.
Example of the actual text message received by 1400+ opt-in participants via cell phone or email.
ERHS: Please evacuate outside to your designated post.

C. Implementation C.

Implementation C is a way of targeting an opt-in SMS/MMS text messaging audience to receive solicited information. In implementation C, the following definitions will apply:

Opt-in: a process by which a user knowingly and voluntarily accepts solicited information delivered via SMS/MMS text messaging or e-mail.

Localized: Information that is restricted to a specific geographic location. The purpose of Implementation C is to provide recipients with additional information pertaining to her or his interests, to provide revenue for the managers of the system (intextmessage.com), and to provide entities with the opportunity to market and advertise to pre-targeted opt-in audience.

The steps for Implementation C are as follows:

Step 1: Individuals register or opt-in to services provided by our system (Intextmessage.com). During this process, individuals identify their interests. All information entered by individuals is localized in order to match users residing in one area with each other.

Step 2: Individuals (now registered web users) join and create SMS/MMS text messaging groups according to their individual interests.

Step 3: Registered web users begin to participate in their respective groups by sending messages out to one another. Accompanying these SMS/MMS text messages, are appended messages/advertisements related to their individual identified interests.

For Implementation C, consider the following scenario:

Person A, Person B and Person C register on our system (Intextmesage.com). Person A identifies his interests as “Computers & Software”. Person B identifies her interests as “Arts & Entertainment”. Person C identifies her interests as “Nightlife & Clubs”. Each person now registered website users join a local hiking group called, “Hiking for beginners”. Person S who has joined this group sometime after, sends out a message to the “Hiking for beginners” group. Each person would receive the following:
Person A: HikingB: We are meeting Saturday at 9 am at crossroads pass—Brought to you by Best Buy
Person B: HikingB: We are meeting Saturday at 9 am at crossroads pass—Brought to you by Century 16 show this text message watch a movie for free.
Person C: HikingB: We are meeting Saturday at 9 am at crossroads pass—Brought to you by DV8 Bar and grill.
Person D thru S: HikingB: We are meeting Saturday at 9 am at crossroads pass—Brought to you by their respective interests.

D. Implementation D.

Implementation D is a way of processing communications among groups and individuals in which the following definitions will apply:

Opt-in: a process by which a user knowingly and voluntarily accepts solicited information delivered via SMS/MMS text messaging or e-mail.

Entity: a group, for-profit or non-profit organization. i.e. businesses, sports clubs, social networks, etc.

Subdomain: a domain that is part of a larger domain i.e. intextmessage.com is the domain, Hikingb.intextmessage.com is the subdomain.

The purpose of Implementation D is to allow an entity, or individuals, to send SMS/MMS text messaging or e-mail without knowing cell phone numbers, e-mail address.

Implementation D adopted the following process:

The system (intextmessage.com) stores and retrieves information pertaining to individual preferences. Sensitive information such as: Cell phone numbers, e-mail addresses are stored in a database and encrypted using triple DES algorithm. Each user is uniquely identified by information they have entered and is assigned a unique ID. Each group is uniquely identified by a group ID/subdomain name. These ID's can be used to send information directly to groups of users or individual users depending on how their respective preferences are set.

Person A and Person B are in the same group. Person B wishes to contact Person A “only”, thus without sending a message to their entire group. Whenever messages are sent to a group, a unique ID coupled with a first name, which is attached to the group message indicating who sent the message. The unique ID can be used communicate directly with that individual.

The following Example applied to Implementation D:
Message sent previously by Person A
Person A.34: HikingB: We are meeting Saturday at 9 am at crossroads pass—Brought to you by Best Buy
Person B would text the following respond to Person A:
Tell-HikingB-34-I'm sorry, Person A I won't be able to make it.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. We claim each method, software process, apparatus, system, network, and combinations thereof as shown and as described directly, indirectly, expressly, and implicitly.
